(19) United States
(12) Patent Application Publication
(10) Pub. No.: US 2024/0347264 A1
(43) Pub. Date: Oct. 17, 2024

(54) INDUCTOR COMPONENT

(71) Applicant: Murata Manufacturing Co., Ltd., Kyoto-fu (JP)

(72) Inventor: Kenta KONDO, Nagaokakyo-shi (JP)

(73) Assignee: Murata Manufacturing Co., Ltd., Kyoto-fu (JP)

(21) Appl. No.: 18/607,967

(22) Filed: Mar. 18, 2024

(30) Foreign Application Priority Data
Apr. 14, 2023 (JP) 2023-066542

(51) Int. Cl. H01F 27/32; H01F 1/153; H01F 17/02

(52) U.S. Cl. CPC H01F 27/32; H01F 1/153; H01F 17/02

(57) ABSTRACT

An inductor component includes a base made of an insulating material; and a coil disposed in the base and helically wound along an axis. The insulating material contains a base material made of an amorphous material containing B, Si, and O and contains a crystalline filler. The base has a high-concentration-phosphorus-containing portion at a position along the coil, and a concentration of P in the base material in the high-concentration-phosphorus-containing portion is higher than a concentration of P in the base material in a central portion of the base.

### CROSS-REFERENCE TO RELATED APPLICATION

This application claims benefit of priority to Japanese Patent Application No. 2023-066542, filed Apr. 14, 2023, the entire content of which is incorporated herein by reference.

### BACKGROUND

### Technical Field

The present disclosure relates to an inductor component.

### Background Art

Japanese Unexamined Patent Application Publication No. 2018-131353 describes an inductor component. This inductor component includes a base containing a glass insulating material and a coil disposed in the base.

An inductor component containing a glass insulating material may have lower strength, and a base of the inductor component may have a crack due to an impact at the time of mounting or a stress at the time of substrate deflection. To solve such a problem, for example, a crystalline filler is added to a glass insulating material. In Japanese Unexamined Patent Application Publication No. 2018-131353, the base is a glass ceramic containing a glass insulating material and a crystalline filler.

### SUMMARY

In such a known inductor component, however, the addition of a crystalline filler to a base may reduce the softening of a glass material and cause a bonding failure (separation) between the base and a coil, and may increase the difference in the coefficient of linear expansion between the base and the coil and cause a crack in the base near the coil due to stress caused by the difference in the coefficient of linear expansion. In particular, the use of a quartz filler, which is effective for reducing the dielectric constant of a glass insulating material, may further reduce the softening of a glass material and further reduce the bonding between a base and a coil.

Accordingly, the present disclosure provides an inductor component that can improve the quality and yield.

An inductor component according to one aspect of the present disclosure includes a base made of an insulating material; and a coil disposed in the base and helically wound along an axis. The insulating material contains a base material made of an amorphous material containing B, Si, and O and contains a crystalline filler. The base has a high-concentration-phosphorus-containing portion at a position along the coil, and a concentration of P in the base material in the high-concentration-phosphorus-containing portion is higher than a concentration of P in the base material in a central portion of the base.

The central portion of the base refers to a portion within a radius of 10 μm from the central point of the base in a cross section of the base including the central point. When the base is approximately cubic, for example, the central point is a point at which the length, the width, and the height of the base are all halved. When the portion within a radius of 10 μm is occupied by the coil and the concentration of P in the base material cannot be detected, the central portion is expanded to a portion within a radius of 20 μm from the central point. The concentration of P in the base material is a ratio of P based on the base material and is an element concentration when a scanning electron microscope (SEM) image of the base material portion of the base is subjected to elemental analysis by energy dispersive X-ray spectroscopy (EDX). The terms “B”, “Si”, “O”, and “P”, as used herein, refer to the corresponding element represented by each symbol, and the phrase “containing the element”, as used herein, refers not to containing the element itself but to containing the element as a compound.

According to this aspect, the base includes the high-concentration-phosphorus-containing portion at a position along the coil, and the concentration of P in the base material in the high-concentration-phosphorus-containing portion is higher than the concentration of P in the base material in the central portion of the base. This tends to soften the high-concentration-phosphorus-containing portion (phosphorus-containing glass), can ensure close contact between the coil and the high-concentration-phosphorus-containing portion along the coil at the time of firing, can improve the bonding between the base and the coil, and can suppress separation between the base and the coil. Furthermore, the high-concentration-phosphorus-containing portion (phosphorus-containing glass) has a high coefficient of linear expansion, can reduce the difference in the coefficient of linear expansion between the coil and the high-concentration-phosphorus-containing portion along the coil, and can reduce the occurrence of a crack in the base near the coil due to stress caused by the difference in the coefficient of linear expansion between the base and the coil in the product after firing. This can improve the quality and yield of the inductor component.

Preferably, in an embodiment of the inductor component, the high-concentration-phosphorus-containing portion is present at a position within 10 μm from the surface of the coil.

According to this embodiment, the high-concentration-phosphorus-containing portion can cover the coil in a film form and can relatively decrease the volume of the high-concentration-phosphorus-containing portion in the base. This can reduce the dielectric constant of the base, reduce the dielectric loss, and improve the coil characteristics.

Preferably, in an embodiment of the inductor component, the concentration of P in the base material in the high-concentration-phosphorus-containing portion is at least 1.5 times the concentration of P in the base material in the central portion of the base.

According to this embodiment, the concentration of P in the base material in the high-concentration-phosphorus-containing portion can be relatively increased, the bonding between the base and the coil can be further improved, and the difference in the coefficient of linear expansion between the base and the coil can be further reduced.

Preferably, in an embodiment of the inductor component, the coil includes a first coil wire and a second coil wire stacked adjacent to each other in an axial direction. The high-concentration-phosphorus-containing portion includes a first high-concentration-phosphorus-containing portion covering at least part of a surface of the first coil wire facing the second coil wire, and a second high-concentration-phosphorus-containing portion covering at least part of a surface of the second coil wire facing the first coil wire. The base has an interlayer portion located between the first high-concentration-phosphorus-containing portion and the second high-concentration-phosphorus-containing portion, and a concentration of P in the base material in the interlayer portion is lower than a concentration of P in the base material in the first high-concentration-phosphorus-containing portion and is lower than a concentration of P in the base material in the second high-concentration-phosphorus-containing portion.

According to this embodiment, the concentration of P in the base material in the interlayer portion of the base can be relatively decreased. This can reduce the dielectric constant of the base, reduce the dielectric loss, and improve the coil characteristics.

Preferably, in an embodiment of the inductor component, the coil partially encloses an amorphous material containing B, Si, and O.

The phrase “the coil partially encloses an amorphous material”, as used herein, refers to a state in which the amorphous material is not completely embedded in the coil and is partially exposed from the outer peripheral surface of the coil.

According to this embodiment, the coil partially encloses the amorphous material. Thus, it is thought that in a sintering step of a method for producing an inductor component, liquid phase sintering proceeds to such an extent that the amorphous material reaches the surface from the inside of the coil. This further improve the smoothness of the coil and can further increase the Q value at a high frequency.

Furthermore, a high-frequency current preferentially flows through the surface of the coil due to the skin effect. Thus, the amorphous material partially enclosed in the coil increases the surface area of the coil and reduces the electrical resistance. This can further increase the Q value at a high frequency.

Preferably, in an embodiment of the inductor component, the coil completely encloses an amorphous material containing B, Si, and O.

The phrase “the coil completely encloses an amorphous material”, as used herein, refers to a state in which the amorphous material is completely embedded in the coil and is not exposed from the outer peripheral surface of the coil.

According to this embodiment, when the coil completely encloses the amorphous material, an interface between the coil and the amorphous material is formed in the coil. This increases the surface area of the coil and reduces the electrical resistance due to the skin effect at a high frequency. Thus, the inductor component according to the present embodiment can further increase the Q value at a high frequency.

Preferably, in an embodiment of the inductor component, the crystalline filler contains any of Al, Si, Ti, Zr, Ca, Mg, Fe, and Mn.

According to this embodiment, the inductor component can have further improved strength.

Preferably, in an embodiment of the inductor component, the crystalline filler is a quartz particle or a crystalline silica particle.

According to this embodiment, the base can have a lower dielectric constant, and the inductor component can have improved characteristics.

Preferably, in an embodiment of the inductor component, the crystalline filler content of the high-concentration-phosphorus-containing portion is 80% or more and 120% or less (i.e., from 80% to 120%) of the crystalline filler content of the central portion of the base.

According to this embodiment, the crystalline filler content is not decreased in the high-concentration-phosphorus-containing portion. Thus, in the high-concentration-phosphorus-containing portion, the crystalline filler content can be ensured, and the strength of the base can be ensured.

On the other hand, a higher crystalline filler content of the high-concentration-phosphorus-containing portion may result in less softening of the high-concentration-phosphorus-containing portion and weaker bonding between the base and the coil, and may result in a larger difference in the coefficient of linear expansion between the high-concentration-phosphorus-containing portion (base) and the coil and the occurrence of a crack in the base near the coil due to stress caused by the difference in the coefficient of linear expansion. However, a high concentration of P in the base material of the high-concentration-phosphorus-containing portion can promote the softening of the high-concentration-phosphorus-containing portion and improve the bonding between the base and the coil, and at the same time reduce the difference in the coefficient of linear expansion between the high-concentration-phosphorus-containing portion (base) and the coil and reduce the occurrence of a crack in the base near the coil.

Thus, it is possible to provide an inductor component with a high yield while ensuring the strength of the base.

Preferably, in an embodiment of the inductor component, the coil includes a plurality of coil wires stacked along the axis. Also, in a cross section including the axis, a concentration distribution of P in the base material in the high-concentration-phosphorus-containing portion covering at least part of a periphery of one coil wire is different from a concentration distribution of P in the base material in the high-concentration-phosphorus-containing portion covering at least part of a periphery of another coil wire.

The phrase “a concentration distribution is different” means that, for example, the thickness and the concentration of the high-concentration-phosphorus-containing portion on the inside, the outside, or the inter-wire side of one coil wire are different from the thickness and the concentration of the high-concentration-phosphorus-containing portions on the corresponding inside, outside, or inter-wire side of the other coil wire. According to this embodiment, in a cross section including the axis, the concentration distribution of P in the base material of the high-concentration-phosphorus-containing portion becomes random and irregular due to a different coil wire. This can uniformly improve the bonding between the base and the coil in the entire inductor component and reduce the difference in the coefficient of linear expansion between the base and the coil.

The inductor component according to one aspect of the present disclosure can have improved quality and yield.

### BRIEF DESCRIPTION OF THE DRAWINGS

FIG. 1 is a transparent perspective view of a first embodiment of an inductor component;

FIG. 2 is an exploded perspective view of an inductor component;

FIG. 3 is a plan view of a layer including a coil wire in the lowest layer of FIG. 2;

FIG. 4 is a cross-sectional view taken along the line IV-IV of FIG. 1;

FIG. 5 is a partial enlarged view of FIG. 4;

FIG. 6A is an explanatory view of a method for producing an inductor component;

FIG. 6B is an explanatory view of a method for producing an inductor component;

FIG. 6C is an explanatory view of a method for producing an inductor component; and

FIG. 7 is a plan view of a layer of a second embodiment of an inductor component.

### DETAILED DESCRIPTION

An inductor component according to one aspect of the present disclosure is described in detail below with reference to embodiments illustrated in the drawings. It should be noted that some of the drawings are schematic and do not necessarily reflect actual dimensions and ratios.

### First Embodiment

### Configuration

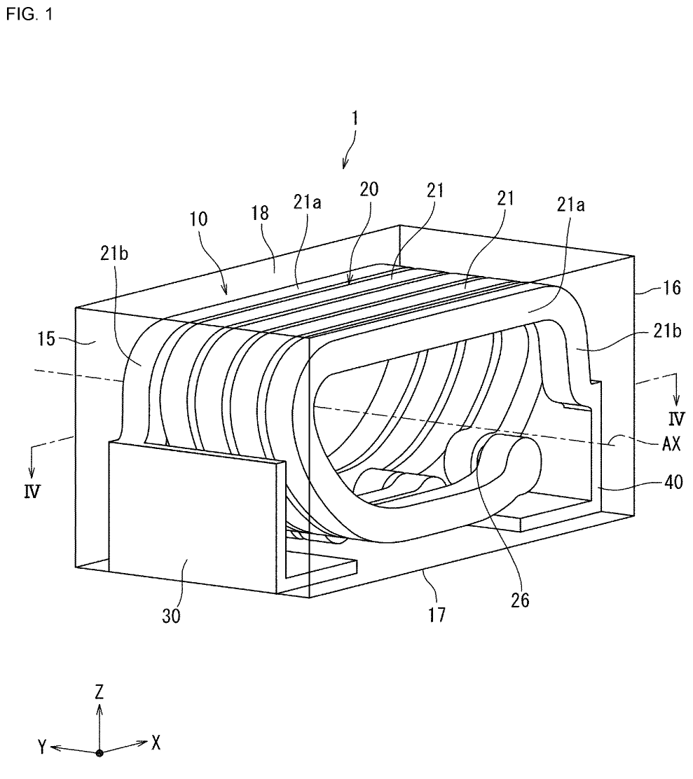

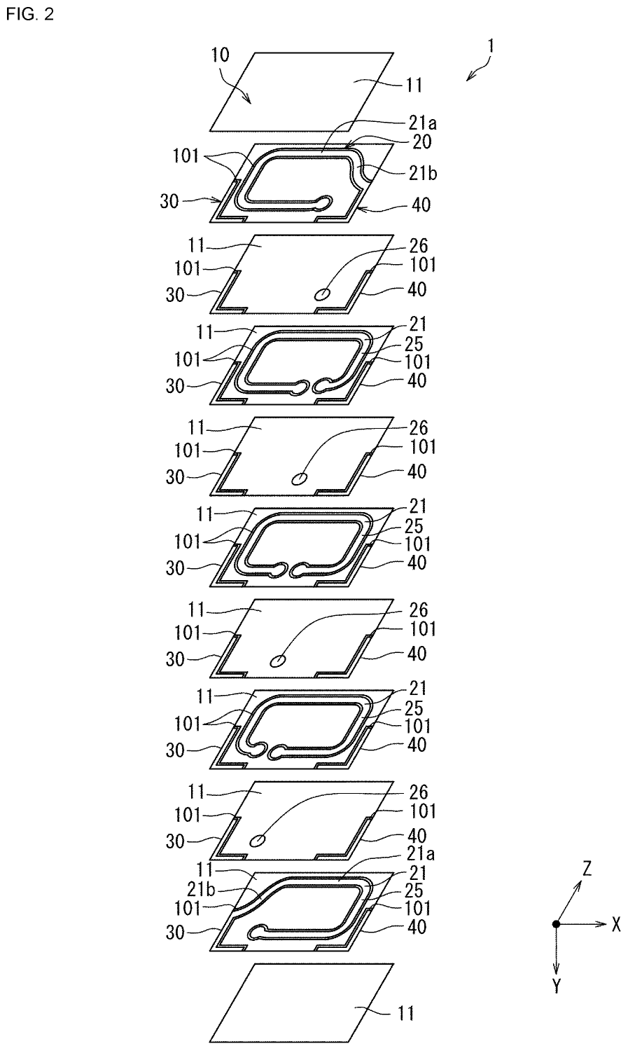

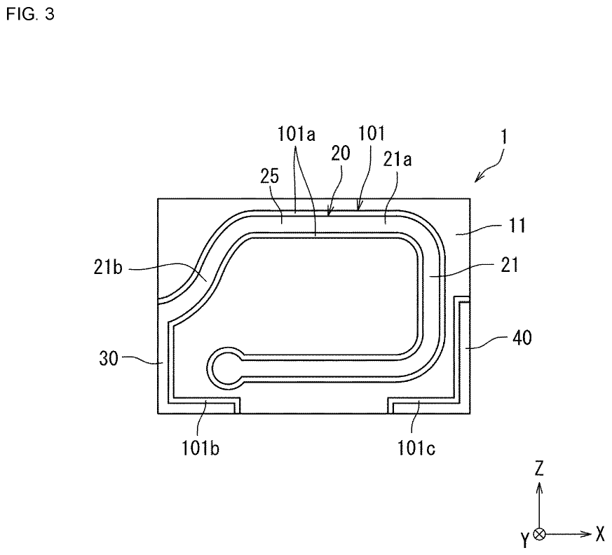

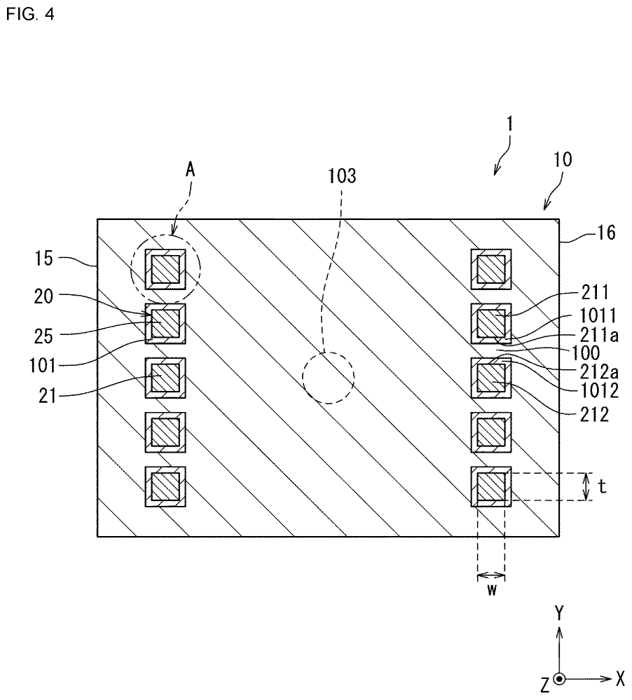

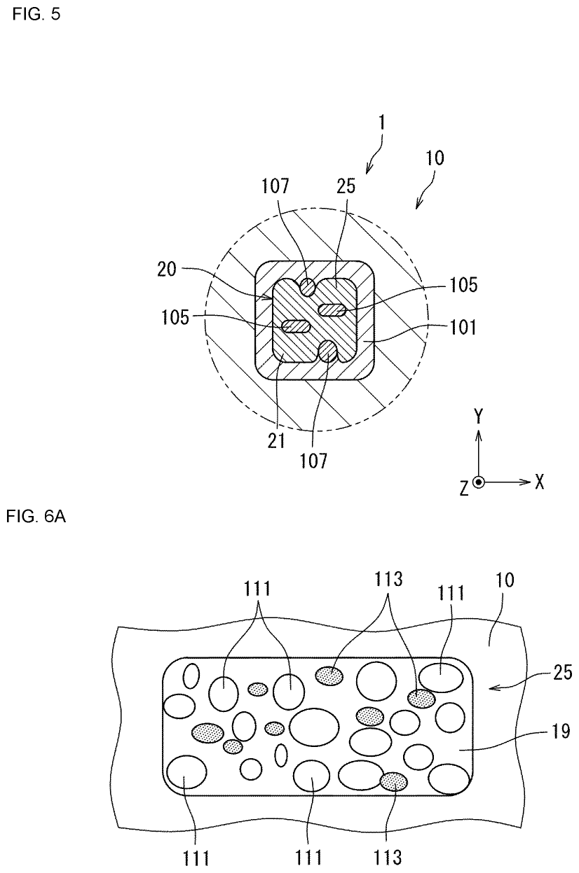

FIG. 1 is a transparent perspective view of a first embodiment of an inductor component. FIG. 2 is an exploded perspective view of an inductor component. FIG. 3 is a plan view of a layer including a coil wire in the lowest layer of FIG. 2. FIG. 4 is a cross-sectional view taken along the line IV-IV of FIG. 1. FIG. 5 is a partial enlarged view of FIG. 4 (an enlarged view of the portion A).

As illustrated in FIGS. 1 and 2, an inductor component 1 includes a base 10, a coil 20 disposed in the base 10, and a first outer electrode 30 and a second outer electrode 40 electrically connected to the coil 20. In FIG. 1, the base 10 is transparently illustrated so that the internal structure of the base 10 can be easily understood. In FIG. 1, a high-concentration-phosphorus-containing portion 101 is not illustrated so that the internal structure of the base 10 can be easily understood.

The inductor component 1 is electrically connected to a wire of a circuit board (not shown) via the first and second outer electrodes 30 and 40. The inductor component 1 is used as, for example, an impedance matching coil (matching coil) of a high-frequency circuit and is used in an electronic device, such as a personal computer, a DVD player, a digital camera, a TV set, a mobile phone, car electronics, or medical/industrial machinery. The application of the inductor component 1 is not limited thereto, and the inductor component 1 can also be used in, for example, a tuned circuit, a filter circuit, a rectifier circuit, or the like.

The base 10 is formed in an approximately rectangular parallelepiped shape. The surface of the base 10 includes a first end surface 15, a second end surface 16 facing the first end surface 15, a bottom surface 17 connected between the first end surface 15 and the second end surface 16, and a top surface 18 facing the bottom surface 17. As illustrated in the drawings, the X direction is a direction perpendicular to the first end surface 15 and the second end surface 16, the Y direction is a direction parallel to the first end surface 15, the second end surface 16, and the bottom surface 17, and the Z direction is a direction perpendicular to the X direction and the Y direction and to the bottom surface 17. The inductor component 1 may have any shape, such as a cylindrical shape, a polygonal columnar shape, a truncated cone shape, or a truncated polygonal pyramid shape.

The base 10 is a multilayer body of a plurality of insulating layers 11. The stacking direction of the insulating layers 11 is a direction (Y direction) parallel to the first and second end surfaces 15 and 16 and to the bottom surface 17 of the base 10. Thus, the insulating layers 11 are layered in the XZ plane. The term “parallel”, as used herein, is not limited to a strictly parallel relationship and also includes a substantially parallel relationship in consideration of a realistic range of variation. In the base 10, the interfaces between the plurality of insulating layers 11 may be unclear due to sintering or the like.

The insulating layers 11 of the base 10 are made of an insulating material. The insulating material contains a base material made of an amorphous material containing B, Si, and O and contains a crystalline filler. When the base 10 contains a crystalline filler, the base 10 can reduce the occurrence of a crack due to an impact at the time of mounting or a stress at the time of substrate deflection. In such a case, the inductor component 1 according to the present embodiment can have higher strength. The amorphous material containing B, Si, and O is, for example, borosilicate glass containing B, Si, and O. The amorphous material may include, in addition to borosilicate glass, for example, glass containing SiO₂, B₂O₃, K₂O, Li₂O, CaO, ZnO, Bi₂O₃, P₂O₅, and/or Al₂O₃, for example, SiO₂—B₂O₃—K₂O glass, SiO₂—B₂O₃—Li₂O—Ca glass, SiO₂—B₂O₃—P₂O₅ glass, SiO₂—B₂O₃—Li₂O—CaO—ZnO glass, or Bi₂O₃—B₂O₃—SiO₂—Al₂O₃ glass. Two or more of these glasses may be used in combination.

The crystalline filler preferably contains, for example, any of Al, Si, Ti, Zr, Ca, Mg, Fe, and Mn. A crystalline filler containing any of these elements can further improve the strength of the inductor component 1. The crystalline filler is preferably, for example, quartz particles or crystalline silica particles. This can reduce the dielectric constant of the base 10 and improve the characteristics of the inductor component 1.

The first outer electrode 30 and the second outer electrode 40 are composed of, for example, an electrically conductive material, such as Ag or Cu. The first outer electrode 30 has, for example, an L shape provided over the first end surface 15 and the bottom surface 17. The second outer electrode 40 has, for example, an L shape provided over the second end surface 16 and the bottom surface 17.

The first outer electrode 30 does not protrude from the first end surface 15 and the bottom surface 17, but may protrude from at least one of the first end surface 15 and the bottom surface 17. The second outer electrode 40 does not protrude from the second end surface 16 and the bottom surface 17, but may protrude from at least one of the second end surface 16 and the bottom surface 17.

The first outer electrode 30 may be provided only on the bottom surface 17 without being provided on the first end surface 15. Likewise, the second outer electrode 40 may be provided only on the bottom surface 17 without being provided on the second end surface 16. In other words, the first outer electrode 30 and the second outer electrode 40 may be provided at least on the bottom surface 17.

The coil 20 is made of, for example, an electrically conductive material and an amorphous material similar to those of the first and second outer electrodes 30 and 40. The coil 20 is helically wound along an axis AX. A first end of the coil 20 is connected to the first outer electrode 30, and a second end of the coil 20 is connected to the second outer electrode 40. In the present embodiment, the coil 20 and the first and second outer electrodes 30 and 40 are integrated without a clear boundary. However, the present disclosure is not limited thereto, and the coil 20 and the outer electrodes may be formed of different materials or by different methods so that there is a boundary therebetween.

The coil 20 is formed in an approximately elliptical shape when viewed in the axis AX direction, but is not limited to this shape. The shape of the coil 20 may be, for example, circular, elliptical, rectangular, another polygonal, or a combination thereof. The axis AX of the coil 20 refers to the central axis of the helix around which the coil 20 is wound. In the inductor component 1, the axis AX direction of the coil 20 is the same as the stacking direction of the insulating layers 11. The axis AX direction of the coil 20 may be perpendicular to the stacking direction of the insulating layers 11.

The coil 20 has a helically wound winding portion 21a and a lead portion 21b that electrically connects the winding portion 21a to the outer electrodes 30 and 40. The coil 20 includes a coil wire 21 wound along a plane. A plurality of coil wires 21 are stacked in the axis AX direction. The coil wire 21 is formed by being wound on the main surface (XZ plane) of the insulating layers 11 perpendicular to the axis AX direction. The coil wires 21 adjacent to each other in the stacking direction are electrically arranged in series through a via-conductor 26 penetrating the insulating layers 11 in the thickness direction (Y direction). In this way, the plurality of coil wires 21 constitute a helix while being electrically connected to each other in series. More specifically, the coil 20 has a configuration in which the plurality of coil wires 21 electrically connected to each other and having the number of turns of less than one are stacked, and has a helical shape. The coil wire 21 is composed of one coil conductor layer 25. The coil wire 21 has the winding portion 21a wound along a plane and the lead portion 21b electrically connecting the winding portion 21a to the outer electrodes 30 and 40. The coil wire 21 (the coil conductor layer 25) is formed on the insulating layers 11.

As illustrated in FIGS. 3, 4, and 5, the base 10 has the high-concentration-phosphorus-containing portion 101 at a position along the coil 20. The high-concentration-phosphorus-containing portion 101 covers at least part of each coil wire 21 along each coil wire 21. The high-concentration-phosphorus-containing portion 101 is in contact with the coil wire 21. More specifically, the high-concentration-phosphorus-containing portion 101 has a first portion 101a covering at least part of the coil wire 21 along the coil wire 21, a second portion 101b covering at least part of the first outer electrode 30 along the first outer electrode 30, and a third portion 101c covering at least part of the second outer electrode 40 along the second outer electrode 40.

The concentration of P in the base material in the high-concentration-phosphorus-containing portion 101 is higher than the concentration of P in the base material in a central portion 103 of the base 10. In the present embodiment, the central point serving as a reference of the central portion 103 is a point corresponding to a half of the bottom surface 17 in the X direction and the Y direction and a half of the first end surface 15 in the Z direction.

The high-concentration-phosphorus-containing portion 101 covers the entire periphery of the coil 20, but may partially cover the coil 20. In other words, the base 10 may have the high-concentration-phosphorus-containing portion 101 at a position along a portion of the coil 20. More specifically, the high-concentration-phosphorus-containing portion 101 may cover only the inner peripheral side of the coil 20. In other words, the base 10 may have the high-concentration-phosphorus-containing portion 101 at a position along the inner periphery of the coil 20. Thus, the high-concentration-phosphorus-containing portion 101 may be in contact with the inner edge of the coil 20. The high-concentration-phosphorus-containing portion 101 may cover only the outer peripheral side of the coil 20. In other words, the base 10 may have the high-concentration-phosphorus-containing portion 101 at a position along the outer periphery of the coil 20. Thus, the high-concentration-phosphorus-containing portion 101 may be in contact with the outer edge of the coil 20.

According to this configuration, the base 10 has the high-concentration-phosphorus-containing portion 101 at a position along the coil 20, and the concentration of P in the base material in the high-concentration-phosphorus-containing portion 101 is higher than the concentration of P in the base material in the central portion 103 of the base 10. This can ensure close contact between the coil 20 and the high-concentration-phosphorus-containing portion 101 along the coil 20 at the time of firing because the high-concentration-phosphorus-containing portion 101 (phosphorus-containing glass) is easily softened. This can also improve the bonding between the base 10 and the coil 20 and suppress separation between the base 10 and the coil 20. This can also reduce the difference in the coefficient of linear expansion between the coil 20 and the high-concentration-phosphorus-containing portion 101 along the coil 20 because the high-concentration-phosphorus-containing portion 101 (phosphorus-containing glass) has a large coefficient of linear expansion, and reduce the occurrence of a crack in the base 10 near the coil 20 due to stress caused by the difference in the coefficient of linear expansion between the base 10 and the coil 20 in the product after firing. This can improve the quality and yield of the inductor component 1.

In short, the present inventors have focused on the fact that phosphorus-containing glass has a relatively low softening point (melting point) and tends to have a high coefficient of linear expansion, and further have found that when phosphorus-containing glass is fired at a high temperature for an extended period, there is an effect that a phosphorus element is easily segregated (phase splitting) near the coil 20. In other words, the present inventors have found that a phosphorus element is segregated near the coil 20 by adjusting the firing temperature and the firing time of phosphorus-containing glass. For example, when phosphorus-containing borosilicate glass is used as a glass material, it was confirmed that at a firing temperature of 800° C. to 900° C. and for a firing time of 30 to 60 minutes P in the glass as a base material of the base 10 approached a metal element of the coil 20 and could be phase-split near the coil 20. On the basis of these findings, the present inventors have derived a configuration in which the high-concentration-phosphorus-containing portion 101 with a low softening point and a high coefficient of linear expansion is provided at a position along the coil 20.

Furthermore, the base 10 includes the high-concentration-phosphorus-containing portion 101 at a position along the coil 20, and the surface of the coil 20 can be made smooth by liquid phase sintering because the high-concentration-phosphorus-containing portion 101 (phosphorus-containing glass) has a low softening point. This can reduce the loss of the electric current flowing through the coil 20. In particular, a high-frequency current preferentially flows through the surface of the coil 20 due to the skin effect and can further reduce the loss of the electric current. This can increase the Q value of the inductor component 1.

Preferably, the high-concentration-phosphorus-containing portion 101 is present at a position within 10 μm from the surface of the coil 20. According to this configuration, the high-concentration-phosphorus-containing portion 101 can cover the coil 20 in a film form and can relatively decrease the volume of the high-concentration-phosphorus-containing portion 101 in the base 10. This can reduce the dielectric constant of the base 10, reduce the dielectric loss, and improve the coil characteristics.

Preferably, the concentration of P in the base material in the high-concentration-phosphorus-containing portion 101 is at least 1.5 times the concentration of P in the base material in the central portion 103 of the base 10. In a method for measuring the concentration of P in the base material, for example, the concentration of P in the base material can be determined in a cross section of the base 10 from the concentration distribution using fluorescence spectroscopy, ICP, WDX, or the like. More specifically, the average value of the concentration of P in the base material is determined from a cross-sectional image of the central portion 103 parallel to the XZ plane perpendicular to the stacking direction. Likewise, the average value of the concentration of P in the base material is determined from a cross-sectional image of the high-concentration-phosphorus-containing portion 101. The average value of the concentration of P in the base material of the high-concentration-phosphorus-containing portion 101 is compared with the average value of the concentration of P in the base material of the central portion 103 of the base 10.

This configuration can relatively increase the concentration of Pin the base material in the high-concentration-phosphorus-containing portion 101, can further improve the bonding between the base 10 and the coil 20, and can further reduce the difference in the coefficient of linear expansion between the base 10 and the coil 20.

As illustrated in FIG. 4, the coil 20 has a first coil wire 211 and a second coil wire 212 stacked adjacent to each other in the axis AX direction. In FIG. 4, the coil wire of the second layer from the top is the first coil wire 211, and the coil wire of the third layer from the top is the second coil wire 212, but other coil wires may be the first coil wire 211 and the second coil wire 212.

The first coil wire 211 has an opposite surface 211a facing the second coil wire 212. The second coil wire 212 has an opposite surface 212a facing the first coil wire 211. The high-concentration-phosphorus-containing portion 101 includes a first high-concentration-phosphorus-containing portion 1011 that covers at least part of the opposite surface 211a of the first coil wire 211 and a second high-concentration-phosphorus-containing portion 1012 that covers at least part of the opposite surface 212a of the second coil wire 212.

The base 10 has an interlayer portion 100 between the first high-concentration-phosphorus-containing portion 1011 and the second high-concentration-phosphorus-containing portion 1012. The concentration of P in the base material in the interlayer portion 100 is lower than the concentration of P in the base material in the first high-concentration-phosphorus-containing portion 1011 and is lower than the concentration of P in the base material in the second high-concentration-phosphorus-containing portion 1012.

According to this configuration, the concentration of P in the base material in the interlayer portion 100 of the base 10 can be relatively decreased. This can reduce the dielectric constant of the base 10, reduce the dielectric loss, and improve the coil characteristics.

Although the coil 20 has an approximately square cross-sectional shape as illustrated in FIG. 4, the coil 20 may have another shape. The cross-sectional shape of the coil 20 may be, for example, circular, elliptical, rectangular, another polygonal, or a combination thereof. The coil 20 having an approximately rectangular cross-sectional shape with a high aspect ratio has an increased cross-sectional area and lower resistance to a high-frequency current, which can further increase the Q value. The aspect ratio is (the thickness t of the coil wire 21)/(the width w of the coil wire 21). The width w of the coil wire 21 is the width of the coil 20 in a direction perpendicular to the axis AX direction in a cross section perpendicular to the extension direction of the coil wire 21. The thickness t of the coil wire 21 is the thickness of the coil 20 in the axis AX direction in a cross section perpendicular to the extension direction of the coil wire 21.

As illustrated in FIG. 5, preferably, the coil 20 partially encloses an amorphous material (hereinafter referred to as exposed glass 107). The amorphous material contains B, Si, and O and is made of, for example, the same material as the amorphous material contained in the base 10. The phrase “the coil 20 partially encloses an amorphous material”, as used herein, refers to a state in which the amorphous material is not completely embedded in the coil 20 and is partially exposed from the outer peripheral surface of the coil 20.

According to this configuration, in a sintering step of a method for producing the inductor component 1, it is thought that liquid-phase sintering has proceeded to such an extent that the amorphous material reaches the surface from the inside of the coil 20. This can further improve the smoothness of the coil 20 and further increase the Q value at a high frequency.

Furthermore, a high-frequency current preferentially flows through the surface of the coil 20 due to the skin effect. Thus, when the coil 20 partially encloses the exposed glass 107, a recessed portion is formed on the surface of the coil 20 and increases the surface area of the coil 20. This reduces the electrical resistance. This can further increase the Q value at a high frequency.

As illustrated in FIG. 5, preferably, the coil 20 completely encloses an amorphous material (hereinafter referred to as enclosed glass 105). The phrase “the coil 20 completely encloses an amorphous material”, as used herein, refers to a state in which the amorphous material is completely embedded in the coil and is not exposed from the outer peripheral surface of the coil 20.

According to this configuration, when the coil 20 completely encloses the enclosed glass 105, an interface between the coil 20 and the enclosed glass 105 is formed in the coil 20. This increases the surface area of the coil 20 and reduces the electrical resistance due to the skin effect at a high frequency. This can further increase the Q value at a high frequency.

As illustrated in FIG. 5, preferably, the crystalline filler content of the high-concentration-phosphorus-containing portion 101 is 80% or more and 120% or less (i.e., from 80% to 120%) of the crystalline filler content of the central portion 103 of the base 10.

The crystalline filler content is calculated, for example, from the area of crystalline filler per unit area in a cross section of the base 10. More specifically, the ratio of the area of crystalline filler per unit area is determined from a cross-sectional image (SEM image) of the central portion 103 parallel to the XZ plane perpendicular to the stacking direction. This ratio corresponds to the crystalline filler content of the central portion 103 of the base 10. Likewise, the ratio of the area of crystalline filler per unit area is determined from a cross-sectional image of the high-concentration-phosphorus-containing portion 101. This ratio corresponds to the crystalline filler content of the high-concentration-phosphorus-containing portion 101.

According to this configuration, the crystalline filler content is not decreased in the high-concentration-phosphorus-containing portion 101. Thus, in the high-concentration-phosphorus-containing portion 101, the amount of crystalline filler can be ensured, and the strength of the base 10 can be ensured.

On the other hand, a higher crystalline filler content of the high-concentration-phosphorus-containing portion 101 may result in less softening of the high-concentration-phosphorus-containing portion 101 and weaker bonding between the base 10 and the coil 20, and may result in a larger difference in the coefficient of linear expansion between the high-concentration-phosphorus-containing portion 101 (the base 10) and the coil 20 and the occurrence of a crack in the base 10 near the coil due to stress caused by the difference in the coefficient of linear expansion. However, a high concentration of P in the base material of the high-concentration-phosphorus-containing portion 101 can promote the softening of the high-concentration-phosphorus-containing portion 101 and improve the bonding between the base 10 and the coil 20, and at the same time reduce the difference in the coefficient of linear expansion between the high-concentration-phosphorus-containing portion 101 (the base 10) and the coil 20 and reduce the occurrence of a crack in the base 10 near the coil.

Thus, it is possible to provide the inductor component 1 with a high yield while ensuring the strength of the base 10.

As illustrated in FIG. 4, preferably, the plurality of coil wires 21 include one coil wire 21 and another coil wire 21, and in a cross section including the axis AX the concentration distribution of P in the base material in the high-concentration-phosphorus-containing portion 101 covering at least part of the periphery of the one coil wire 21 is different from the concentration distribution of P in the base material in the high-concentration-phosphorus-containing portion 101 covering at least part of the periphery of the other coil wire 21. For example, in the high-concentration-phosphorus-containing portion 101 covering the one coil wire 21, the concentration of P in the base material is highest on the outer peripheral side of the one coil wire 21, and in the high-concentration-phosphorus-containing portion 101 covering the other coil wire 21, the concentration of P in the base material is highest on the inner peripheral side of the other coil wire 21. The position where the high-concentration-phosphorus-containing portion is thickest may be different instead of the position of a portion with a high concentration. In FIG. 4, any one of the coil wires 21 of the five layers is the one coil wire 21, and another of the coil wires 21 of the five layers is the other coil wire 21.

According to this configuration, in a cross section including the axis AX, the concentration distribution of P in the base material of the high-concentration-phosphorus-containing portion 101 becomes random and irregular due to a different coil wire 21. This can uniformly improve the bonding between the base 10 and the coil 20 in the entire inductor component 1 and reduce the difference in the coefficient of linear expansion between the base 10 and the coil 20.

### Method for Producing Inductor Component

An example of a method for producing an inductor component is described below with reference to FIG. 2. The method for producing an inductor component includes a mother multilayer body forming step of forming a mother multilayer body, a cutting step of cutting the mother multilayer body to form a multilayer body, a sintering step of sintering the multilayer body, and a polishing step of polishing the sintered multilayer body.

### Mother Multilayer Body Forming Step

The mother multilayer body is an assembly in which a plurality of multilayer bodies are collectively formed. Members in an assembled state are described below with the same names and reference numerals as those of the members after being separated.

In the mother multilayer body forming step, an insulating layer 11 is formed, and a conductor layer is formed on the insulating layer 11. This step is repeated to stack a plurality of insulating layers 11 each having the conductor layer. Thus, the mother multilayer body is formed. A mother multilayer body forming step using a screen printing method is described below.

### 1. Preparation of Paste

An insulating paste, a conductive paste, and a conductive paste for an outer electrode are prepared. The insulating paste contains a filler material (an example of a crystalline filler), a glass material made of an amorphous material (an example of a base material; more specifically, a glass powder), and a solvent. The amorphous material is, for example, borosilicate glass. The glass material contains phosphorus. The crystalline filler is, for example, ceramic. The insulating paste may further contain an organic material or a composite material, and among these, a material with a low dielectric constant or dielectric loss is preferred. The organic material is, for example, a polymer (more specifically, an epoxy resin, an acrylic resin, a fluoropolymer, or the like). The composite material is, for example, a glass epoxy resin.

The conductive paste contains a glass material made of an amorphous material, an electrically conductive material (more specifically, a metal powder), and a solvent. The electrically conductive material is preferably a high electrically conductive material, for example, Ag, Cu, or Au. The conductive paste for an outer electrode contains an electrically conductive material and a solvent and does not contain a glass material made of an amorphous material.

### 2. Formation of Insulating Layer for Outer Layer

The insulating layer for an outer layer (insulating paste layer) 11 corresponds to the first insulating layer 11 from the bottom in FIG. 2. The insulating paste is applied to a substrate (not shown), such as a carrier film, by a screen printing method. This step is repeated to form the insulating layer for an outer layer 11 with a predetermined thickness.

### 3. Formation of Insulating Layer (First Layer) Including Conductor Layer

The insulating paste is applied to the insulating layer for an outer layer 11 by a screen printing method to form an insulating layer 11. This insulating layer 11 corresponds to the second insulating layer 11 from the bottom in FIG. 2.

The conductive paste is then applied in a predetermined pattern to the insulating layer 11 by a screen printing method to form a conductor layer. The conductor layer may be formed not only by the screen printing method but also by a photolithography method using a photosensitive conductive paste. More specifically, a photosensitive conductive paste layer is exposed to active energy radiation (more specifically, ultraviolet radiation or the like) through a photomask corresponding to a desired coil pattern. The exposure is followed by development with a developer (more specifically, an alkaline solution or the like). Thus, the coil conductor layer 25 with a desired coil pattern is formed. Likewise, an outer conductor layer with a desired pattern is formed using the conductive paste for an outer electrode. Thus, the insulating layer 11 including the coil conductor layer 25 and the outer conductor layer is formed.

### 4. Formation of Insulating Layer (Second Layer) Including Conductor Layer

An insulating layer including a conductor layer 11 of the second layer is formed. This insulating layer 11 corresponds to the third insulating layer 11 from the bottom in FIG. 2. The insulating layer 11 of the second layer has an opening and a via-hole and does not include the coil conductor layer 25 and is different in this point from the insulating layer 11 of the first layer.

An insulating paste is applied to the insulating layer 11 of the first layer to form an insulating paste layer. A predetermined portion of the insulating paste layer is irradiated with a laser beam to form the insulating layer 11 with an opening and a via-hole. A conductive layer is formed in the opening and the via-hole by a screen printing method. Thus, the insulating layer 11 including the conductor layer and the via-conductor 26 is formed.

### 5. Formation of Insulating Layer (Third Layer) Including Conductor Layer

An insulating layer including a conductor layer 11 of the third layer is formed. This insulating layer 11 corresponds to the fourth insulating layer 11 from the bottom in FIG. 2. The insulating layer 11 of the third layer includes the coil conductor layer 25 and is different in this point from the insulating layer 11 of the second layer.

A predetermined portion of an insulating paste layer is irradiated with a laser beam to form the insulating layer 11 with an opening and a via-hole on the insulating layer 11 of the second layer. The conductive paste is applied in a desired pattern to form a conductor layer. Thus, the coil conductor layer 25 is formed in the via-hole and on the insulating layer 11, and an outer conductor layer is formed in the opening. The insulating layer 11 of the third layer is formed.

### 6. Stacking

The steps of forming the insulating layers 11 of the second layer and the third layer are repeated to form insulating layers 11 of the fourth and subsequent layers. The insulating layers 11 of the fourth and subsequent layers correspond to the fifth to tenth insulating layers 11 from the bottom in FIG. 2. An insulating layer for an outer layer 11 is then formed. This insulating layer for an outer layer 11 corresponds to an insulating layer 11 of the eleventh layer from the bottom in FIG. 2. A mother multilayer body is produced in this manner.

A mark layer may be formed before and after the formation of the insulating layer for an outer layer 11. The mark layer is, for example, colored by mixing an insulating paste with a filler.

A spin coating method or a spray coating method may be used instead of the screen printing method.

The mother multilayer body may include, as the lowest layer, an insulating layer 11 that does not include a conductor layer.

The opening and the via-hole may be formed by laser or drilling after pressure bonding, spin coating, or spray coating of an insulating material sheet, or by a photolithography method using a photosensitive insulating paste.

In the formation of a conductor layer, a plurality of conductor layers may be formed and stacked to form a conductor layer having a cross-sectional shape (rectangle) with a high aspect ratio. The plurality of conductor layers may be formed by performing the screen printing method and the photolithography method multiple times or may be formed by combining other methods.

Instead of the conductive paste layer, a conductor layer may be formed by a sputtering method, a vapor deposition method, a foil pressure bonding method, or the like. The patterning of the conductor layer is not limited to the screen printing method and may be a subtractive method (more specifically, a photolithography method or the like) or an additive method (more specifically, a semi-additive method or the like). The semi-additive method is, for example, a method of forming a negative pattern, then forming a plating film, and removing an unnecessary portion.

In the mother multilayer body forming step, the mother multilayer body may be produced by forming the second, fourth, sixth, eighth, and tenth insulating layers 11 from the bottom in FIG. 2 and the insulating layer for an outer layer 11. The inductor component 1 produced by this method has a structure in which insulating layers including a coil conductor layer are directly stacked.

### Cutting Step

In the cutting step, the mother multilayer body is cut to form a multilayer body. For example, the mother multilayer body is cut by dicing or the like such that the outer conductor layer is exposed from a section, thereby forming a plurality of green multilayer bodies.

### Sintering Step

In the sintering step, a multilayer body is sintered. Because the material of the insulating layer 11 (the insulating paste) contains phosphorus, when a multilayer body is fired at a high temperature (800° C. or more), the phosphorus element can be segregated near the coil wire 21 and form the high-concentration-phosphorus-containing portion 101 along the coil wire 21. The segregation of the high-concentration-phosphorus-containing portion 101 is controlled by the temperature and time for firing. Provided that the phosphorus element segregates near the coil wire 21, the firing temperature may be 800° C. or less. In another method of segregating the phosphorus element, phosphorus-containing glass may be used as a material of the coil wire 21 (the conductive paste). Thus, a multilayer body can be fired to exude the phosphorus-containing glass around the coil wire 21 as the sintered body of the conductive paste and segregate phosphorus near the coil wire 21.

In this manner, the high-concentration-phosphorus-containing portion 101 can be formed at a position along the coil 20. The high-concentration-phosphorus-containing portion 101 does not need to completely cover the coil 20 and may be provided at a position along the coil 20. More specifically, provided that the high-concentration-phosphorus-containing portion 101 is in contact with the coil 20, the high-concentration-phosphorus-containing portion 101 may be partially located, for example, only on the inner peripheral side or only on the outer peripheral side of the coil 20. The high-concentration-phosphorus-containing portion 101 may be located along the outer edge and the inner edge of the coil 20.

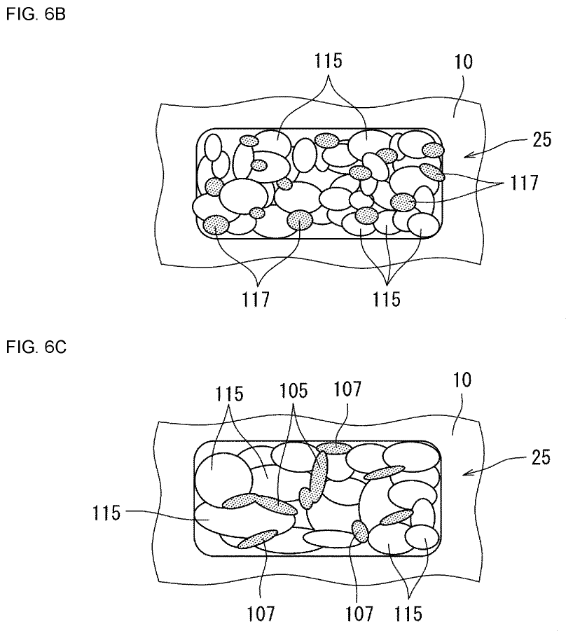

The formation of the coil conductor layer 25 in the sintering step is described below with reference to FIGS. 6A to 6C. FIGS. 6A to 6C are cross-sectional views showing changes in the coil conductor layer 25 in the sintering step. As illustrated in FIG. 6A, the coil conductor layer 25 before sintering is a conductor paste in which metal particles 111 and glass particles 113 are dispersed in a varnish 19.

When sintering is started in this state, as illustrated in FIG. 6B, the solvent is diffused by combustion, and adjacent metal particles 111 are locally contracted (necking) and sintered and form a metal portion 115. At this time, the glass particles 113 are softened, flow between the metal portions 115, and form a glass portion 117.

At this time, as illustrated in FIG. 6C, the softened glass portion 117 is pushed outward due to the contraction of the metal particles 111 and moves to the outer peripheral edge of the coil conductor layer 25. Thus, the surface of the coil conductor layer 25 is sintered in the extruded softened glass (the glass portion 117), that is, in the liquid phase, which further promotes the sintering and often causes smoothing of the surface and crystal growth. This decreases the number of crystal grain boundaries that inhibit the flow of an electric current, and reduces electrical resistance that leads to loss. This can further increase the Q value of the inductor component 1. At this time, the enclosed glass 105 and the exposed glass 107 are formed as the glass portion 117. The enclosed glass 105 is formed as a result of the glass portion 117 located at a position farther than the outer peripheral edge of the coil conductor layer 25 remaining in the coil conductor layer 25 without being pushed out. The exposed glass 107 is formed as a result of the glass portion 117 located at a position relatively close to the outer peripheral edge of the coil conductor layer 25 not being completely pushed out and remaining near the surface of the coil conductor layer 25. Thus, as illustrated in FIGS. 6A-6C described later, the formed coil conductor layer 25 includes the metal portion 115 and the glass portion 117, and the glass portion 117 includes the enclosed glass 105 and the exposed glass 107.

The ratio of the enclosed glass 105 in the glass portion 117 depends on the amount of the exposed glass 107 to be pushed out and can be controlled by using, as a measure, the degree of contraction on the basis of the degree of progress of sintering, more specifically, the volume of the metal particles 111. The degree of contraction of the metal particles 111 is controlled, for example, by the temperature and time for firing.

### Polishing Step

In the polishing step, for example, a sintered multilayer body is polished by barrel finishing.

### Other Steps

The method for producing the inductor component 1 may further include a plating step. The plating step is performed after the polishing step to plate the outer conductor layer exposed on the outer surface of the multilayer body. After the polishing step and before the plating step, a conductor layer may be further provided on the outer conductor layer of the multilayer body by a dipping method, a sputtering method, or the like using a conductive paste.

### Second Embodiment

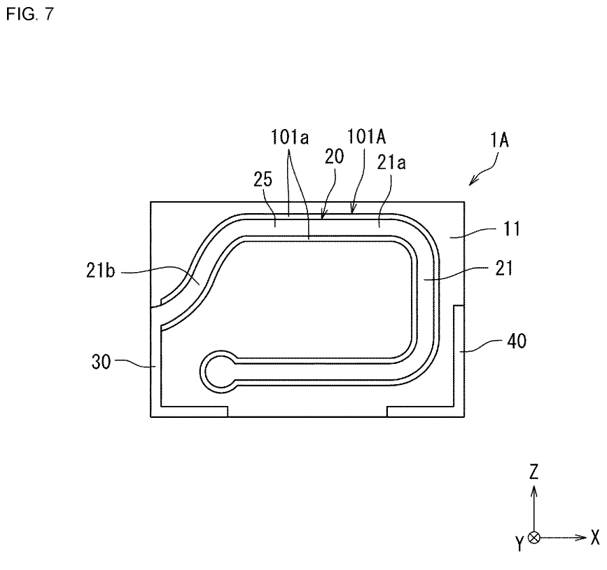

FIG. 7 is a plan view illustrating a second embodiment of the inductor component 1A and corresponding to FIG. 3. The second embodiment is different from the first embodiment in the configuration of the high-concentration-phosphorus-containing portion. This different configuration is described below. In the second embodiment, the same component as in the first embodiment is denoted by the same reference numeral and is not described here.

As illustrated in FIG. 7, in the inductor component 1A of the second embodiment, a high-concentration-phosphorus-containing portion 101A includes only a first portion 101a covering at least part of a coil wire 21 along the coil wire 21. In other words, the high-concentration-phosphorus-containing portion 101A does not include the second portion 101b and the third portion 101c of the first embodiment. According to this configuration, the high-concentration-phosphorus-containing portion 101A covers only the coil wire 21 and can relatively decrease the volume of the high-concentration-phosphorus-containing portion 101A in the base 10. This can reduce the dielectric constant of the base 10, reduce the dielectric loss, and improve the coil characteristics.

It should be noted that the present disclosure is not limited to these embodiments, and design changes can be made without departing from the gist of the present disclosure. For example, the features of the first and second embodiments may be combined in various ways.

The high-concentration-phosphorus-containing portion is provided along all the coil wires in the above embodiment but may be provided along at least one coil wire.

The coil partially encloses the exposed glass in the above embodiment but does not necessarily enclose the exposed glass.

The coil completely encloses the enclosed glass in the above embodiment but does not necessarily enclose the enclosed glass.

The present disclosure includes the following aspects.

<1> An inductor component comprising a base made of an insulating material; and a coil disposed in the base and helically wound along an axis. The insulating material contains a base material made of an amorphous material containing B, Si, and O and contains a crystalline filler. The base has a high-concentration-phosphorus-containing portion at a position along the coil, and a concentration of P in the base material in the high-concentration-phosphorus-containing portion is higher than a concentration of P in the base material in a central portion of the base.

<2> The inductor component according to <1>, wherein the high-concentration-phosphorus-containing portion is present at a position within 10 μm from a surface of the coil.

<3> The inductor component according to <1> or <2>, wherein the concentration of P in the base material in the high-concentration-phosphorus-containing portion is at least 1.5 times the concentration of P in the base material in the central portion of the base.

<4> The inductor component according to any one of <1> to <3>, wherein the coil includes a first coil wire and a second coil wire stacked adjacent to each other in an axial direction. The high-concentration-phosphorus-containing portion includes a first high-concentration-phosphorus-containing portion covering at least part of a surface of the first coil wire facing the second coil wire, and a second high-concentration-phosphorus-containing portion covering at least part of a surface of the second coil wire facing the first coil wire. Also, the base has an interlayer portion located between the first high-concentration-phosphorus-containing portion and the second high-concentration-phosphorus-containing portion, and a concentration of P in the base material in the interlayer portion is lower than a concentration of P in the base material in the first high-concentration-phosphorus-containing portion and is lower than a concentration of P in the base material in the second high-concentration-phosphorus-containing portion.

<5> The inductor component according to any one of <1> to <4>, wherein the coil partially encloses an amorphous material containing B, Si, and O.

<6> The inductor component according to any one of <1> to <5>, wherein the coil completely encloses an amorphous material containing B, Si, and O.

<7> The inductor component according to any one of <1> to <6>, wherein the crystalline filler contains any of Al, Si, Ti, Zr, Ca, Mg, Fe, and Mn.

<8> The inductor component according to any one of <1> to <7>, wherein the crystalline filler is a quartz particle or a crystalline silica particle.

<9> The inductor component according to any one of <1> to <8>, wherein a crystalline filler content of the high-concentration-phosphorus-containing portion is 80% or more and 120% or less (i.e., from 80% to 120%) of a crystalline filler content of the central portion of the base.

<10> The inductor component according to according to any one of <1> to <9>, wherein the coil includes a plurality of coil wires stacked along the axis. Also, in a cross section including the axis, a concentration distribution of P in the base material in the high-concentration-phosphorus-containing portion covering at least part of a periphery of one coil wire is different from a concentration distribution of P in the base material in the high-concentration-phosphorus-containing portion covering at least part of a periphery of another coil wire.

What is claimed is:

1. An inductor component comprising:
a base including an insulating material; and
a coil disposed in the base and helically wound along an axis,
wherein
the insulating material includes a base material made of an amorphous material containing B, Si, and O and includes a crystalline filler,
the base has a high-concentration-phosphorus-containing portion at a position along the coil, and
a concentration of P in the base material in the high-concentration-phosphorus-containing portion at the position along the coil is higher than a concentration of P in the base material in a central portion of the base.

2. The inductor component according to claim 1, wherein
the high-concentration-phosphorus-containing portion is at a position within 10 μm from a surface of the coil.

3. The inductor component according to claim 1, wherein
the concentration of P in the base material in the high-concentration-phosphorus-containing portion is at least 1.5 times the concentration of P in the base material in the central portion of the base.

4. The inductor component according to claim 1, wherein
the coil includes a first coil wire and a second coil wire stacked adjacent to each other in an axial direction,
the high-concentration-phosphorus-containing portion includes a first high-concentration-phosphorus-containing portion covering at least part of a surface of the first coil wire facing the second coil wire, and a second high-concentration-phosphorus-containing portion covering at least part of a surface of the second coil wire facing the first coil wire, and
the base has an interlayer portion between the first high-concentration-phosphorus-containing portion and the second high-concentration-phosphorus-containing portion, and a concentration of P in the base material in the interlayer portion is lower than a concentration of P in the base material in the first high-concentration-phosphorus-containing portion and is lower than a concentration of P in the base material in the second high-concentration-phosphorus-containing portion.

5. The inductor component according to claim 1, wherein
the coil partially encloses an amorphous material containing B, Si, and O.

6. The inductor component according to claim 1, wherein
the coil completely encloses an amorphous material containing B, Si, and O.

7. The inductor component according to claim 1, wherein
the crystalline filler contains any of Al, Si, Ti, Zr, Ca, Mg, Fe, and Mn.

8. The inductor component according to claim 1, wherein
the crystalline filler is a quartz particle or a crystalline silica particle.

9. The inductor component according to claim 1, wherein
a crystalline filler content of the high-concentration-phosphorus-containing portion is from 80% to 120% of a crystalline filler content of the central portion of the base.

10. The inductor component according to claim 1, wherein
the coil includes a plurality of coil wires stacked along the axis, and
in a cross section including the axis, a concentration distribution of P in the base material in the high-concentration-phosphorus-containing portion covering at least part of a periphery of one coil wire is different from a concentration distribution of P in the base material in the high-concentration-phosphorus-containing portion covering at least part of a periphery of another coil wire.

11. The inductor component according to claim 2, wherein
the concentration of P in the base material in the high-concentration-phosphorus-containing portion is at least 1.5 times the concentration of P in the base material in the central portion of the base.

12. The inductor component according to claim 2, wherein
the coil includes a first coil wire and a second coil wire stacked adjacent to each other in an axial direction,
the high-concentration-phosphorus-containing portion includes a first high-concentration-phosphorus-containing portion covering at least part of a surface of the first coil wire facing the second coil wire, and a second high-concentration-phosphorus-containing portion covering at least part of a surface of the second coil wire facing the first coil wire, and
the base has an interlayer portion between the first high-concentration-phosphorus-containing portion and the second high-concentration-phosphorus-containing portion, and a concentration of P in the base material in the interlayer portion is lower than a concentration of P in the base material in the first high-concentration-phosphorus-containing portion and is lower than a concentration of P in the base material in the second high-concentration-phosphorus-containing portion.

13. The inductor component according to claim 2, wherein
the coil partially encloses an amorphous material containing B, Si, and O.

14. The inductor component according to claim 2, wherein
the coil completely encloses an amorphous material containing B, Si, and O.

15. The inductor component according to claim 2, wherein
the crystalline filler contains any of Al, Si, Ti, Zr, Ca, Mg, Fe, and Mn.

16. The inductor component according to claim 2, wherein
the crystalline filler is a quartz particle or a crystalline silica particle.

17. The inductor component according to claim 2, wherein
a crystalline filler content of the high-concentration-phosphorus-containing portion is from 80% to 120% of a crystalline filler content of the central portion of the base.

18. The inductor component according to claim 2, wherein
the coil includes a plurality of coil wires stacked along the axis, and
in a cross section including the axis, a concentration distribution of P in the base material in the high-concentration-phosphorus-containing portion covering at least part of a periphery of one coil wire is different from a concentration distribution of P in the base material in the high-concentration-phosphorus-containing portion covering at least part of a periphery of another coil wire.
